(19) United States
(12) Patent Application Publication
(10) Pub. No.: US 2020/0042954 A1
(43) Pub. Date: Feb. 6, 2020

(54) SYSTEM AND METHOD FOR PROVIDING PREDICTIVE MAINTENANCE AND ASSET TRACKING IN A PLUMBING SYSTEM

(71) Applicant: Katie Parris, Bellevue, WA (US)

(72) Inventor: Katie Parris, Bellevue, WA (US)

(21) Appl. No.: 16/530,330

(22) Filed: Aug. 2, 2019

Related U.S. Application Data
(60) Provisional application No. 62/714,235, filed on Aug. 3, 2018.

(51) Int. Cl. G06Q 10/00; G06N 20/00; G06N 5/04; G06Q 30/06; G06Q 10/10

(52) U.S. Cl. CPC G06Q 10/20; G06N 20/00; G06Q 10/1097; G06Q 30/0633; G06N 5/04

(57) ABSTRACT

A method for operating a system providing predictive maintenance and asset tracking in a plumbing system involves operating a user interface on a mobile device to receive work site details for a work site, operate a wireless sensor to detect an asset tag and collect diagnostic information. The method further involves communicating the work site details, the asset tag, the diagnostic information, and the imaging information to a heuristics engine; selecting work site layout, plumbing diagram, and location regulations from a worksite database, selecting a part description, part history, tolerances, and servicing information from a parts database, identifying a maintenance schedule and maintenance solutions for the plumbing part, generating suggested maintenance for other related plumbing parts and displaying maintenance information, suggested maintenance, and part description through the user interface.

### CROSS-REFERENCE TO RELATED APPLICATIONS

This application claims the benefit of U.S. provisional patent application Ser. No. 62/714,235, filed on Aug. 3, 2018, the contents of which are incorporated herein by reference in their entirety.

### BACKGROUND

Plumbing systems at many facilities can only be repaired or maintained by licensed plumbers. As this is a limited pool of individuals, the management of their time and is essential, especially when they are responsible for multiple facilities in a large area. Therefore, a solution that improves the efficiency of a plumbers is needed.

To make an accurate diagnosis of suggested maintenance, much less part descriptions to be ordered and other servicing information, a plumber must integrate a large amount of site and logistic data: the work site itself must be thoroughly evaluated, including both building-specific conditions (e.g., size/height, age, water conditions, pipe flow volume) and location-specific information within the building (e.g., foot traffic patterns, valve location, environmental factors, water conditions and temperature). These inputs must also be correlated with a job description and potential plumbing parts (e.g., via an asset tag and/or visual evaluation) as a set of instructions for suggested maintenance and ordering corresponding parts. This is not an insignificant challenge given the high variability on the inputs and therefore the complexity of the resulting evaluation(s).

With such high variability of inputs and the continual use of various elements (e.g., water, chemicals, metals), not to mention a number of moving parts, plumbing systems invariably require maintenance. Fortunately, with its lengthy history, plumbing technology has allowed for its maintenance schedule for parts to be relatively consistent and therefore predictable. Still, inputs to a predictive plumbing maintenance system can potentially be quite varied: the type and location of a valve (e.g., shower, toilet, faucet, kitchen sink, lavatory), the problems and/or symptoms encountered (e.g., dripping water, no water, lack of flushing, etc.), the technical difficulty of replacement or repair (e.g., knowledge required, tools, other experts), cost factors of replacement or repair, the current brand and model or specification, the intended use and specialized requirements (e.g., drinking water, reclaimed water, ice machine), the building type, regulations or codes, and owner/operator preferences or goals. Taking all these inputs into account—both individually and in various combinations—is required to accurately predict parts-related maintenance solutions, particularly when integrated with a similarly diagnosed solution.

There is therefore a clear need for a means to process a large number of varying inputs to accurately diagnose a plumbing problem and derive suggested maintenance for parts and service. There is a corresponding need to integrate and process inputs for predictive maintenance based on computer learning taking place during the diagnostic process and provide this feedback in a systematic way.

### BRIEF SUMMARY

The disclosure includes a method for providing predictive maintenance and asset tracking in a plumbing system.

One embodiment of the disclosure includes: operating a user interface on a mobile device to receive work site details comprising location information and a job description for a work site, operating a wireless sensor to detect an asset tag and collect diagnostic information, from diagnostic sensors, from a plumbing part, and operating an image sensor to capture imaging information from the plumbing part; communicating the work site details, the asset tag, the diagnostic information, and the imaging information to a heuristics engine; selecting a work site layout, a plumbing diagram, and location regulations from a worksite database through a selector configured by the work site details; selecting a part description, a part history, tolerances, and servicing information from a parts database through the selector configured by the asset tag; selecting the part description, the part history, the tolerances, and the servicing information from the parts database through the selector configured by the imaging information; identifying a maintenance schedule and maintenance solutions for the plumbing part through comparison of the part history, the tolerances, the servicing information, and the plumbing diagram to the diagnostic information and the job description through operation of a comparator; generating suggested maintenance for other related plumbing parts through operation of the heuristics engine; and displaying maintenance information comprising the maintenance solutions and the maintenance schedule, the suggested maintenance, and the part description through the user interface.

Another aspect includes a system comprising: a wireless sensor, an image sensor, a mobile device with a user interface, a processor, and a memory. The memory stores instructions that, when executed by the processor, configure the system to operate the user interface on the mobile device to receive work site details comprising location information and a job description for a work site; operate the wireless sensor to detect an asset tag and collect diagnostic information, from diagnostic sensors, from a plumbing part; and operate the image sensor to capture imaging information from the plumbing part. The instructions also configure the system to communicate the work site details, the asset tag, the diagnostic information, and the imaging information to a heuristics engine; and select a work site layout, a plumbing diagram, and location regulations from a worksite database through a selector configured by the work site details. The instructions further select a part description, a part history, tolerances, and servicing information from a parts database through at least one of the selector configured by the asset tag and the selector configured by the imaging information; and identify a maintenance schedule and maintenance solutions for the plumbing part through comparison of the part history, the tolerances, the servicing information, and the plumbing diagram to the diagnostic information and the job description through operation of a comparator. The instructions further generate suggested maintenance for other related plumbing parts through operation of the heuristics engine; and display maintenance information comprising the maintenance solutions and the maintenance schedule, the suggested maintenance, and the part description through the user interface.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system 100 in accordance with one embodiment.

FIG. 2 illustrates a method 200 in accordance with one embodiment.

FIG. 3 illustrates a plumbing layout 300 in accordance with one embodiment.

FIG. 4 illustrates a plumbing layout 400 in accordance with one embodiment.

FIG. 5 illustrates a plumbing layout 500 in accordance with one embodiment.

FIG. 6 illustrates a work site details 600 in accordance with one embodiment.

FIG. 7 illustrates a simplified system 700 in which a server 704 and a client device 706 are communicatively coupled via a network 702.

FIG. 8 illustrates a predictive maintenance diagram 800 in accordance with one embodiment.

FIG. 9 illustrates a basic deep neural network 900 in accordance with one embodiment.

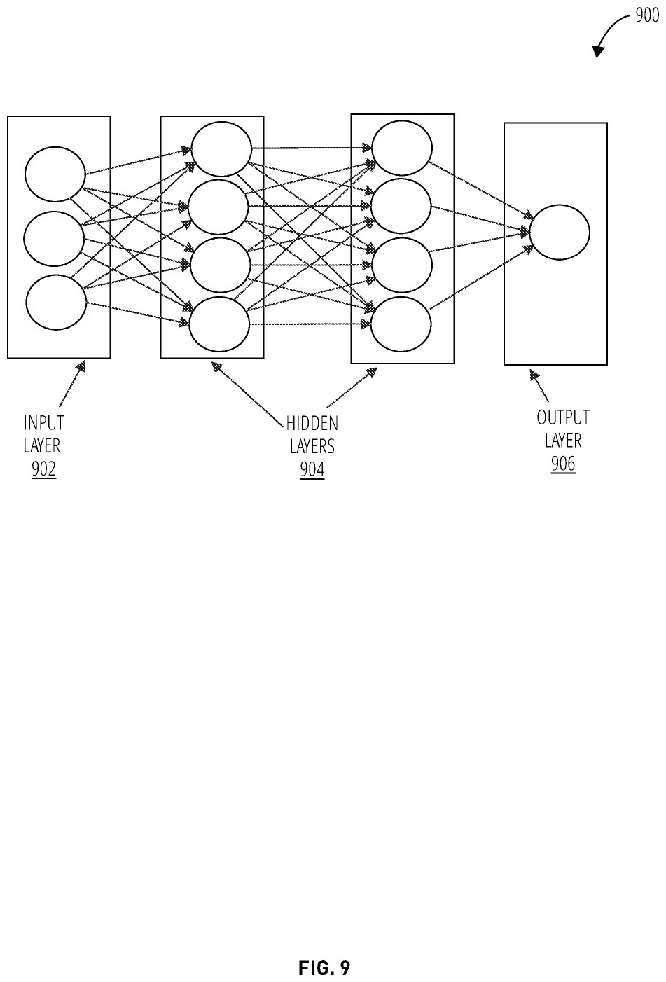

FIG. 10 illustrates an artificial neuron 1000 in accordance with one embodiment.

FIG. 11 illustrates a computing device 1100 in accordance with one embodiment.

### DETAILED DESCRIPTION

“Asset tag” refers to a physical identifier attached to a plumbing part to be detected by a wireless sensor.

“Asset tracking” refers to a means by which assets (e.g., plumbing parts) are identified, analyzed, maintained, ordered and replaced in a plumbing system.

“Building-specific data” refers to information included with work site details, including water conditions, building age, pipe flow volume, building size and building height.

“Bus subsystem” refers to a connecting system within a data processing system used for transporting data between two or more components.

“Client device” refers to a consumer of resources and services in a client/server architecture.

“Communication network interface” refers to a means to connect a bus subsystem to a communications network.

“Communications network” refers to a collection of terminal nodes in which links are connected so as to enable communication between the terminals.

“Comparator” refers to a component of a heuristics engine performing the functions of comparing part history, tolerances, servicing information, and plumbing diagram to diagnostic information and job description.

“Data processing system” refers to a combination of machines, people, and processes that for a set of inputs produces a defined set of outputs.

“Diagnostic information” refers to data collected from diagnostic sensors by a wireless sensor from a plumbing part for the purpose of diagnosing a problem.

“Diagnostic sensors” refers to collectors of diagnostic information from a plumbing part.

“Feature vector” refers to an n-dimensional vector of numerical features in machine learning that represents some object.

“Foot traffic” refers to the amount of use an area receives based on how many people pass through or stay in the area.

“Heuristics engine” refers to an experience-based processing method used to reduce the need for calculations pertaining to equipment size, performance, or operating conditions.

“Image sensor” refers to a device to capture imaging information from a plumbing part.

“Imaging information” refers to data captured by an image sensor from a plumbing part.

“Job description” refers to a data component, along with location information, comprising plumbing work site details.

“Location environmental factors” refers to factors relating to location information, such as indoor, outdoor, air temperature, moisture, and sunlight.

“Location information” refers to data describing conditions within a building, i.e., usage rate or foot traffic, valve type, location environmental factors, water conditions, and water temperature.

“Location regulations” refers to government policies stored in a worksite database.

“Logic” refers to instructions to implement the present disclosure, stored in volatile memory or non-volatile memory.

“Machine learning algorithm” refers to a computational application of artificial intelligence providing the ability to automatically learn and improve from experience without being explicitly programmed.

“Machine learning system” refers to a system including a network, such as a deep neural network, that may be used to collect and analyze data to create predictive models.

“Maintenance information” refers to data comprising maintenance solutions, a maintenance schedule, suggested maintenance, and a part description.

“Maintenance schedule” refers to a time-ordered means of maintaining a plumbing part.

“Maintenance solutions” refers to descriptions of the means of maintaining a plumbing part.

“Mobile device” refers to a transportable computer with a user interface displaying work site details, operating a wireless sensor, and operating an image sensor.

“Non-volatile memory” refers to a type of computer memory that can retrieve stored information even after having been power cycled.

“Ordering service” refers to a service receiving a replacement part order in response to the identification of maintenance solutions.

“Other related plumbing parts” refers to additional plumbing parts than those identified by a wireless sensor or an image sensor, whose suggested maintenance is determined by a heuristics engine.

“Part description” refers to description of a plumbing part, along with a part history, tolerances, and servicing information, contained in a parts database.

“Part history” refers to description of a plumbing part, along with a part description, tolerances, and servicing information, contained in a parts database.

“Parts database” refers to a collection of computer records describing plumbing parts, and including for each part a part description, a part history, tolerances, and servicing information.

“Plumbing diagram” refers to data for a plumbing work site contained in a worksite database.

“Plumbing part” refers to a physical component for the operation of a plumbing system.

“Predictive maintenance inputs” refers to data used as inputs to a machine learning algorithm to feed a predictive model for a plumbing system.

“Predictive model” refers to a process using data analysis and probability to forecast outcomes.

“Replacement part order” refers to communication to an ordering service in response to the identification of plumbing maintenance solutions.

“Selector” refers to a means of selecting a work site layout, a plumbing diagram, and location regulations from a worksite database.

“Servicing information” refers to plumbing data available from a parts database along with a part description, a part history, and tolerances.

“Suggested maintenance” refers to instruction(s) for plumbing part maintenance for other related plumbing parts through operation of the heuristics engine.

“Tolerances” refers to data for a plumbing part in the parts database referring to the allowable deviation from specified or designed values.

“Uniform Plumbing Code” refers to a model code standard plumbing practices and procedures, published by the International Association of Plumbing and Mechanical Officials.

“Usage rate” refers to a data component of location information, referring to how often an area is used; also known as foot traffic.

“User interface” refers to the human-facing display on a mobile device.

“Valve” refers to a location of water source in a plumbing system, e.g., shower, toilet, faucet, sink).

“Valve type” refers to a category of water fixture, e.g., shower, faucet, toilet.

“Volatile memory” refers to a type of computer memory requiring a constant power source to retrieve stored information.

“Water conditions” refers to a data component of location information referring to chemicals, additives, mineral content and particulates.

“Wireless sensor” refers to a device used to detect an asset tag and collect diagnostic information from a plumbing part.

“Work site” refers to the location of a plumbing system.

“Work site details” refers to data comprising location information and a job description for a work site.

“Work site layout” refers to a physical description of a work site, included in a worksite database.

“Worksite database” refers to a collection of computer records containing work site layouts, plumbing diagrams, and location regulations.

A method for operating a system providing predictive maintenance and asset tracking in a plumbing system involves operating a user interface on a mobile device includes: receiving work site details comprising location information and a job description for a work site; operate a wireless sensor to detect an asset tag and collect diagnostic information from diagnostic sensors and/or from a plumbing part; operating an image sensor to capture imaging information from the plumbing part; communicating the work site details, the asset tag, the diagnostic information, and the imaging information to a heuristics engine; selecting a work site layout, plumbing diagram, and location regulations from a worksite database through a selector configured by the work site details; selecting a part description, part history, tolerances, and servicing information from a parts database through the selector configured by the asset tag; selecting the part description, the part history, the tolerances, and the servicing information from the parts database through the selector configured by the imaging information; identifying a maintenance schedule and maintenance solutions for the plumbing part through comparison of the part history, the tolerances, the servicing information, and the plumbing diagram to the diagnostic information and the job description through operation of a comparator; generating suggested maintenance for other related plumbing parts through operation of the heuristics engine; and displaying maintenance information comprising the maintenance solutions, the maintenance schedule, the suggested maintenance, and the part description through the user interface. The method may also involve communicating a replacement part order to an ordering service in response to the identification of the maintenance solutions.

The system allows the customer to have predictive maintenance and asset tracking of the plumbing system. It enables risk management and improves customer experience.

The system may be provided with a software application that includes a dashboard that can be mobile-friendly, allowing the maintenance staff, the manager, or the plumber on site of a facility (e.g. stadium, hospital or a school district) with multiple properties spread out over a fairly large geographic area to operate more efficiently. The application may allow a plumber to predict when something's going to fail and know what else in the current location might be due for maintenance. For instance, if the plumber is shutting down the water, he or she can do an additional service work at the same time.

The system may make suggestions that certain items are within a replacement threshold and should be replaced early to save labor. For example, a toilet may have been flushed a number of times and needs a preventative maintenance done. If there are also six other toilets in this restroom, it may make sense to do maintenance all at the same time.

In order to perform these operations, the system may request/compile information regarding: how critical a specific part is (for example, an industrial water mixing valve in a hotel may be absolutely critical); how long a part has been in use; scheduled maintenance intervals; likely remaining part life; when the part will likely need repairs; maintenance history; frequency of use; vandalism issues; tracking building code changes over time, and; being able to know whether parts are in compliance.

An auto updating machine learning powered database may be provided to aggregate regulations and codes for city, county, and state, as well as location specific policies (e.g., organization/facility specific, (i.e. policy, green building, or hospital rules), associated with the particular job location.

For example, if none of the currently installed parts meets code due to its initial installation date, a substitute plumber from a different location may not know how to navigate the regulations associated with repairing or replacing the part to meet the codes set by the local municipality. In some instances, the regulation may call for the replacement of additional parts at the same time in order to meet the regulations.

The system may also hold warnings based on the age of the parts, for example, the likelihood of the presence of lead, asbestos or other toxic materials.

The system may also track part recalls through a database of posted manufacturer recalls. Because the system is tracking all the parts, it knows what's been installed and where. As recall notices come, the proper person may receive an alert with the locations and items affected by the recall. The system employs a dashboard that would allow the plumber to know all of the relevant alerts.

The system may also allow for facility management to track the staff availability and track inventory of replacement parts. The system may allow plumbing and maintenance departments to carry a lower amount of spare parts and not have to over-buy and maintain a large inventory.

In certain circumstances, business chains may have a roving plumber who maintains plumbing for all the properties, or a plumbing maintenance contractor and a manager, with the businesses management notifying the system, which sends an alert to the contractor. When the system receives the issue, it may automatically populate the work order and order the part. For a company with multiple plumbers, the system may pick a plumber based on location and inventory, or tools on a given truck.

The system may also monitor specifications, and if a substitution has to be made, it may be documented so that a replacement part that is within spec may be substituted at a later date. The system may utilize digitized building plans to locate parts and indicate the proper type and amount of parts which must be used.

The system may also include cleaning procedures for different items, so, e.g., if a sink made of a specific material is vandalized, the system may pull up that this material is of a particular type, and display the proper cleaning procedure for that substance on that material or part, or recommend replacement.

The system may utilize an object recognition database to allow the user to take a picture and identify the part, manufacturer, installation and maintenance procedures, and other associated information

The system may utilize location tracking, for example, RSSI a mesh network, Bluetooth beacons, GPS, etc. The system may track assets utilizing radio frequency, or image-based asset tracking, for example RFID tagging, object recognition, or QR codes.

A part may be associated with a particular maintenance record utilizing an asset tag; if the item is then fixed off-site, it can easily be tracked and returned to the proper location. The system may utilize asset tracking and object recognition to populate information on a heads-up display, the system may utilize asset tags, location data and object recognition to automatically pull information about a specific item and generate a user interface. The system may populate checklists associated with a particular repair and may utilize images submitted by the customer to correlate with such repairs.

The system may utilize machine learning to detect latent patterns that may be contributing to early failure on certain parts. For example, a toilet valve may be failing early in a certain building, and the system may correlate the data and discover that a combination of water softness, chlorine content, water temperature, and frequency of use may cause that early failure. system may then inform the manufacturer and also suggest early pre-failure repairs on similar units with similar usage characteristics.

The system may begin with a survey of the facility, identifying what are the pieces that are critical infrastructure, then determine what are the common problems, what kinds of sensors, may be used to identify those problems. The system may catalog issue common to a particular part or location and display them to the user. A plumber may not have the part but the distributor locally may have it and it could indicate that it is still available fairly quickly versus the lead time at a different distributor. The system may also track sensor placement and may suggest more optimal placement based on the building layout and other factors.

The system may provide individual parts with assets tags. The asset tags may store information about plumbing infrastructure and how to repair or replace the parts or unit. The system may provide a diagnostic database allowing for parts and plumbing systems.

The system may provide replacement integrated with asset tags and diagnostic sensors or provide retrofittable sensors to detect potential failures. The diagnostic sensors may be utilized to determine water quality and water pressure within a plumbing system or at the specific location of the part (e.g., distance from water source, which floor within the building, other conditions that could possibly affect the part durability). Information from the diagnostic sensors may estimate a failure/replacement rate based on a (part failure model—predictive model for when the part would fail under similar conditions) and estimate replacement history for the part (may help narrow when the part was installed and help predict when the part would need to be replaced). The site wide Plumbing System Sensors may also be utilized to detect temperature, Pressure, and Part Cycling within the system to helps determine replacement schedule and when the part was used. The potential sensors that the system may include water temp, water flow rate, water volume, water content/quality, expansion, corrosion, pressure, activation (on/off), traffic/heat map, usage rates, leak detection sensors.

The system may also provide access for support staff, product identification, systems consulting, augmented reality support for plumbing layouts, access to a knowledge base, integration with other tools or systems facilities mapping, and facilities maintenance or work order systems.

The system may also integrate with or incorporate Internet of Things (IoT)/B Tech Platform. Through the use of an IoT platform the system may make it easier for facilities to maintain plumbing systems, reduce the cost of plumbing system maintenance Facilities surveys/mapping, asset management, as well as provide predictive maintenance, augmented reality support, enhanced product identification tools, and facilitated data collection.

The implementation of the system may include an initial consultation to the facility to survey the facility tag assets throughout the facility, group assets by location and type, identify which assets meet building specifications and which do not. The system may then integrate the facility with map beacons and communication tools. The system may also provide the user with the ability to audit the onsite repair and replacement inventory. Additionally, the system may provide a management app to allow the user to quickly setup new assets and assign them to a physical location.

The system may provide an interactive plumbing maintenance tool including integration with the building's control system, a facilities management software/tool kit, and a predictive maintenance tool kit with workflows to help planning suggested work orders and product orders. In an embodiment, the system provides integration with an alarm and reporting system to determine the status or identify critical events occurring at a facility.

Furthermore, the system may allow for just-in-time inventory, so the system can automatically order and schedule maintenance. The system may provide the ability to add the building specification for a particular building to ensure compliance with internal building codes and municipal, county, and state laws (database). The system may also provide information on what the cleaning, removal, and maintenance procedures may be for a particular location.

The system may also utilize the IoT to enable sensors to form a mesh network of sensors. These sensors may be provided with IoT interoperability (different radio protocols) allowing for data integration and collection. The system may collect data about the individual parts, cluster, and use machine learning to find correlations that may allow it to predict why a particular part is breaking. For instance, a certain model of toilet valve may go out very quickly in a localized area, and the system may correlate the different things which those sites have in common (e.g. hard water, traffic volume, large temperature fluctuations). The system may then make recommendations for other locations with similar qualities that employ the same part.

One of skill in the art will realize that the methods and apparatuses of this disclosure describe proscribed functionality associated with a specific, structured graphical interface. Specifically, the methods and apparatuses, inter alia, are directed to a system and method for providing predictive maintenance and asset tracking in a plumbing system displayable through a user interface. One of skill in the art will realize that these methods are significantly more than abstract data collection and manipulation.

Further, the methods provide a technological solution to a technological problem, and do not merely state the outcome or results of the solution. As an example, the system and method for providing predictive maintenance and asset tracking in a plumbing system through a user interface allows for a specifically constructed user interface allowing the display of a relevant components within a plumbing system that require replacement as well as the ability to display tracking information for those components. This is a particular technological solution producing a technological and tangible result. The methods are directed to a specific technique that improves the relevant technology and are not merely a result or effect.

Additionally, the methods produce the useful, concrete, and tangible result of the system and method for providing predictive maintenance and asset tracking in a plumbing system displayable through a user interface, thereby identifying each change as associated with its antecedent rule set.

Further, the methods are directed to a specifically-structured graphical user interface, where the structure is coupled to specific functionality. More specifically, the methods disclose a specific set of information to the user, rather than using conventional user interface methods to display a generic index on a computer.

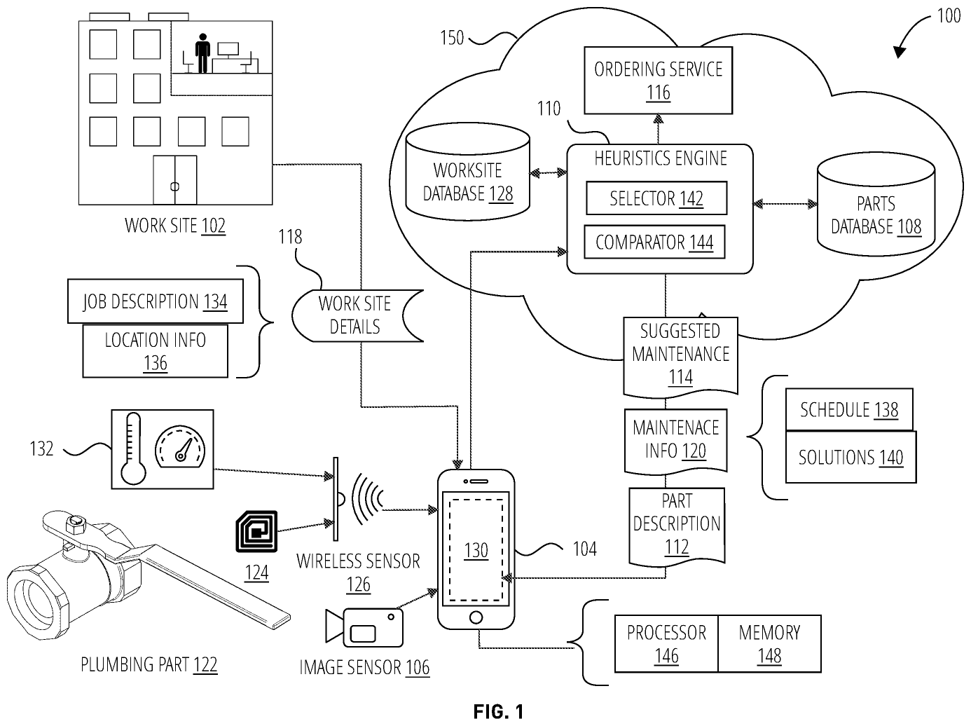

Referencing FIG. 1, the system 100 providing predictive maintenance and asset tracking in plumbing system includes a work site 102, a mobile device 104, a heuristics engine 110, a worksite database 128, a parts database 108, and an ordering service 116. The work site 102 comprises a plumbing part 122 comprising diagnostic sensors 132, and an asset tag 124. The mobile device 104 comprises a wireless sensor 126, an image sensor 106, and a processor 146 and memory 148 to control operations of a user interface 130.

During operation of the system 100, the mobile device 104 receives work site details 118 comprising a job description 134, and a location information 136 for the work site 102 through the work site 102. The job description 134 may provide background regarding the nature of the call to the work site 102 as well as possible scope of the work needed. The location information 136 may provide information such as the physical location of the work site 102 as well as the location of the job within the work site 102. The user interface 130 may display the work site details 118 received from a scheduling service and may provide the user with navigation instructions to find the work site 102 and guidance to find the location of the job within the work site 102. The user may enter the work site details 118 manually or supplement missing details if needed through user interface 130.

While at the work site 102, the user may want to diagnose a problem using the affected parts. The user may gather information on a plumbing part 122 from the plumbing system by using an image sensor 106 and/or a wireless sensor 126. The image sensor 106 may capture imaging information (e.g., an image, imaging code) from the plumbing part 122. If an image of the part is captured, the system 100 may operate an image recognition engine to identify the part from a parts database. The wireless sensor 126 and the imaging image sensor 106 may be utilized to capture the asset tag 124. The asset tag 124 may contain detailed information about the part or a reference to the stored information related to the plumbing part 122 that may be utilized to identify part description, part history, tolerances for the plumbing part 122, and servicing information to repair/replace the plumbing part 122 from a parts database. The wireless sensor 126 may capture diagnostic information (e.g., water temperature, water pressure, usage count, status, water quality, etc.) from the diagnostic sensors 132 coupled to the plumbing part 122. The diagnostic information may provide insight into the usage of the part as well as the environment the part is operating in.

The mobile device 104 communicates the work site details 118, the diagnostic information, the asset tag 124, and the imaging information to the heuristics engine 110. The heuristics engine 110 operates a selector to retrieve the work site layout, plumbing diagram, and location regulations from a worksite database using the work site details 118. The heuristics engine 110 operates the selector 142 to retrieve part description, part history, tolerances (e.g., max weight, water quality, etc.) for the plumbing part 122, and servicing information from the parts database 108 using the asset tag 124 or the processed imaging information identifying the plumbing part 122. The heuristics engine 110 may operate the comparator 144 to identify a maintenance schedule and maintenance solutions for the plumbing part through comparison of the part history, the tolerances, the servicing information, and the plumbing diagram to the diagnostic information and the job description. Once a maintenance solution is detected, the heuristics engine 110 may communicate a replacement part order to an ordering service, if the maintenance solution requires a part replacement. The heuristics engine 110 may also perform some data analytics on the maintenance schedule, maintenance solutions, part history, tolerances, servicing information, the plumbing diagram, the diagnostic information and the job description, as well as information related to other parts operating with the plumbing part 122, and maintenance schedule, maintenance solutions, part history, the plumbing diagram, the diagnostic information, for similar parts at other locations to generate suggested maintenance for the work site 102. The suggested maintenance 114, the part description 112, and the maintenance information 120 comprising the maintenance schedule 138 and the maintenance solutions 140 is then communicated to the mobile device 104 to be displayed in the user interface 130.

Any of the heuristics engine 110, parts database 108, worksite database 128, and ordering service 116 may be located at a remote server 150 and/or remote storage provider. In some embodiments, the remote server 150 may be provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like. The remote storage may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

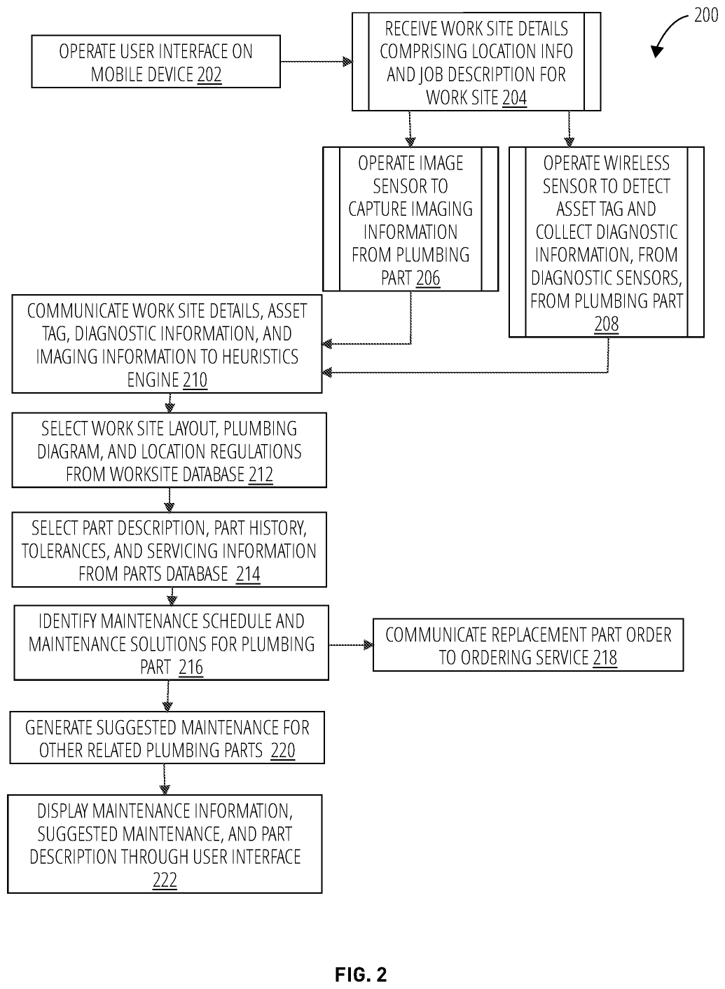

The system 100 may be operated in accordance with the process described in FIG. 2.

Referencing FIG. 2, a method 200 for operating a system providing predictive maintenance and asset tracking in plumbing system involves operating a user interface on a mobile device (block 202) to receive work site details comprising location information and a job description for a work site (subroutine block 204), operate a wireless sensor to detect an asset tag and collect diagnostic information, from diagnostic sensors, from a plumbing part (subroutine block 206), and operate an image sensor to capture imaging information from the plumbing part (subroutine block 208). In block 210, the method 200 communicates the work site details, the asset tag, the diagnostic information, and the imaging information to a heuristics engine. In block 212 the method 200 selects work site layout, plumbing diagram, and location regulations from a worksite database through a selector configured by the work site details. In block 214, the method 200 selects a part description, part history, tolerances, and servicing information from a parts database through the selector. The selector may be configured by the asset tag and/or the imaging information to retrieve the information from the parts database. In block 216, the method 200 identifies a maintenance schedule and maintenance solutions for the plumbing part through comparison of the part history, the tolerances, the servicing information, and the plumbing diagram to the diagnostic information and the job description through operation of a comparator. In block 218, the method 200 communicates a replacement part order to an ordering service in response to the identification of the maintenance solutions. In block 220, the method 200 generates suggested maintenance for other related plumbing parts through operation of the heuristics engine. In block 222, the method 200 displays maintenance information comprising the maintenance solutions and the maintenance schedule, the suggested maintenance, and the part description through the user interface.

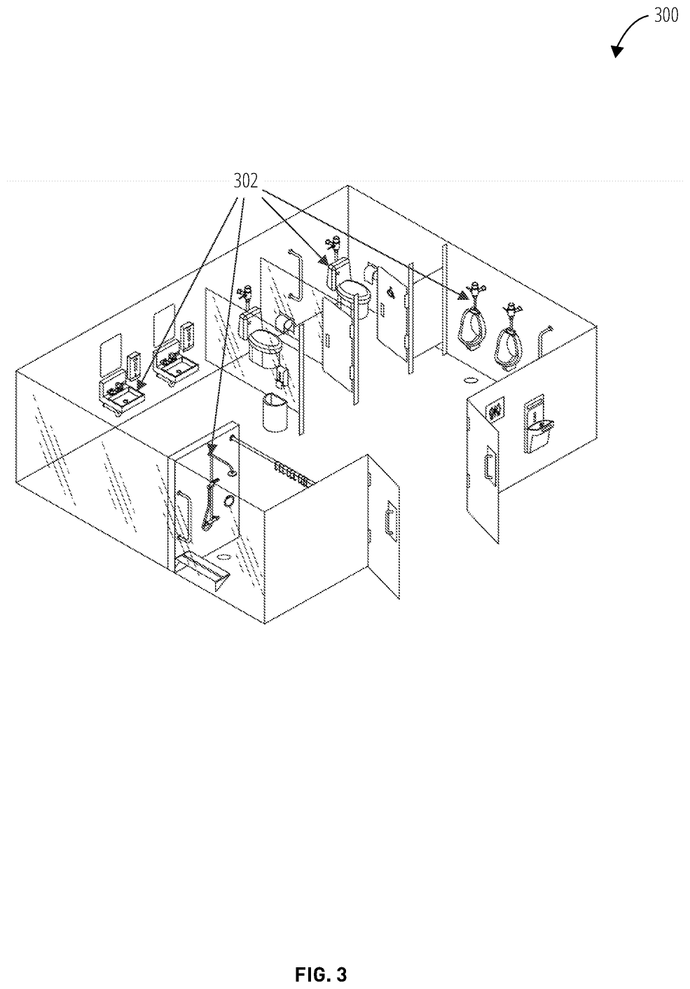

Referencing FIG. 3, a plumbing layout 300 shows an isometric view of a bathroom highlighting the individual plumbing parts that may be damaged. The system 100 provides a user with the ability to identify the parts and subparts or components that may need to be repaired or replaced due to normal usage or vandalism. As an example of said parts, a valve 302 is shown for each valve type, illustrating such exemplary cases as a sink, toilet, urinal and shower.

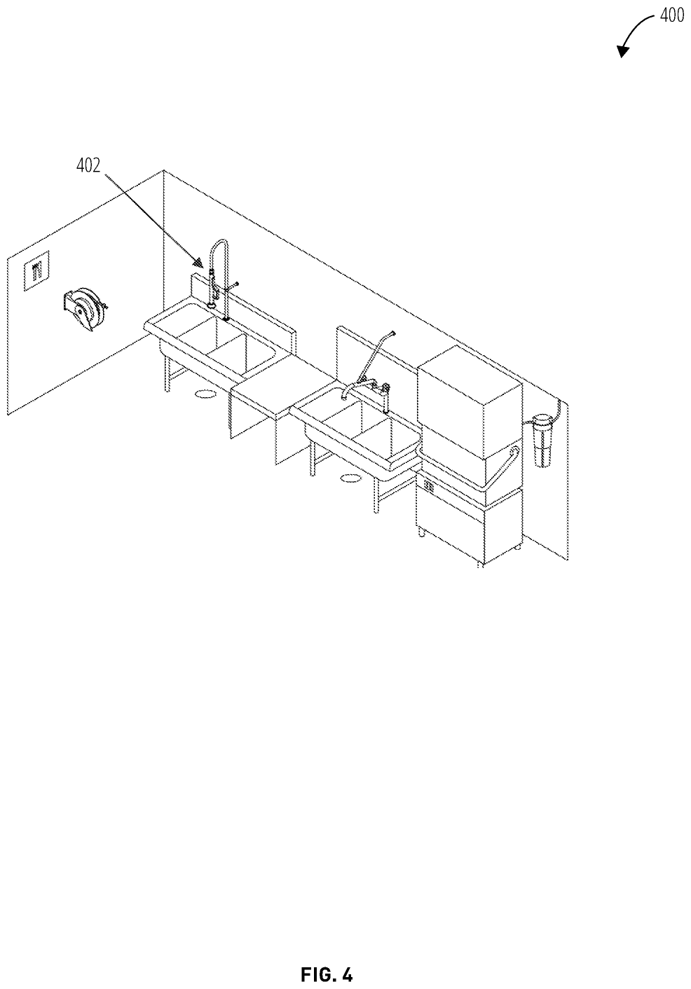

Referencing FIG. 4, the plumbing layout 400 shows an isometric view of a commercial kitchen highlighting the parts that may need to be repaired or replaced. The system may also store maintenance records allowing for the identification of parts that need to be repaired or replaced due to normal usage or vandalism. For example, the hose nozzle 402 in one commercial kitchen may a high incidence of failure that is outside the normal failure rate at other locations, upon further inspection, a user may be able to determine that the issues are caused by vandalism.

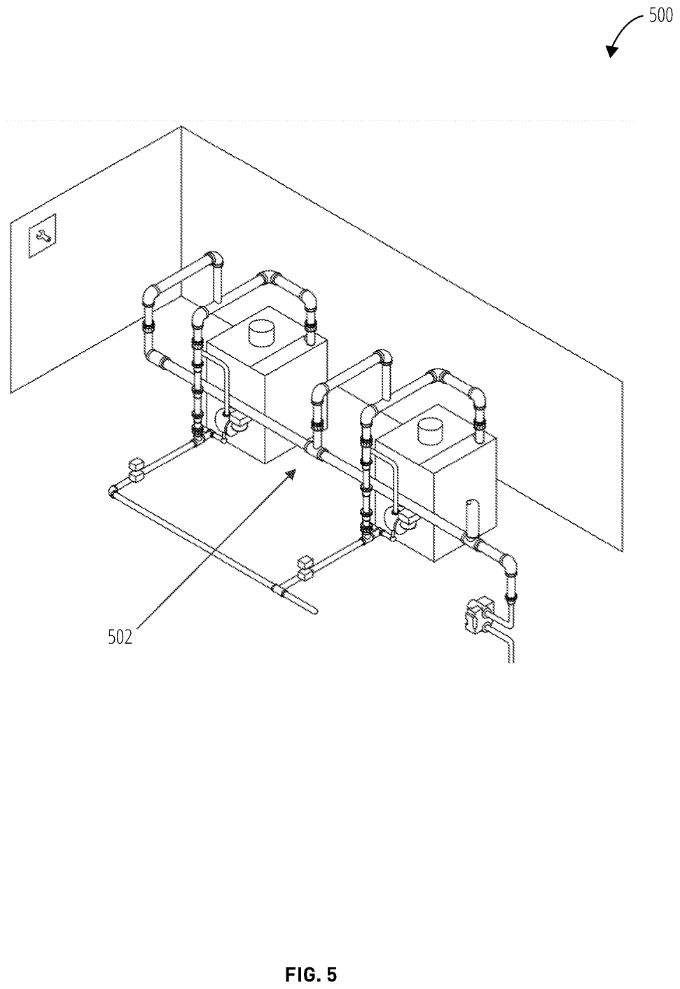

Referencing FIG. 5, the plumbing layout 500 shows an isometric view of complex plumbing system 502. The plumbing system 502 includes many individual parts that may have different rates for repair or replacement as well as requiring certain interventions which may require the water to be cut off for a certain period of time. Depending on the severity of the problem and subsequent solution, a user may be able to triage which parts are the cause of the problem and could possibly fail in the near future, reducing repeat maintenance calls.

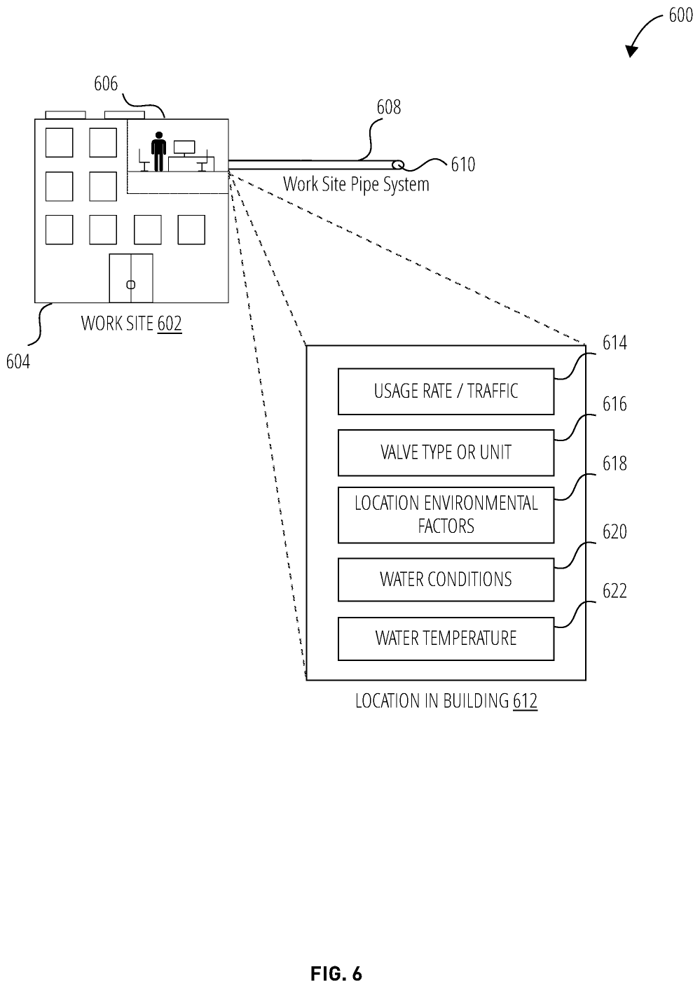

FIG. 6 illustrates work site details 600, including those providing building-specific data and location information, including location regulations.

Referring to the work site 602, the building-specific data comprises two aspects of the building itself and another two aspects related to the pipes located within the building and the water conditions 610 for the flow within the pipes. The work site 602 building provides work site details including building age 604 and building size and height 606. Building age 604 may create plumbing issues as buildings shift and piping wears over time, depending on the volume of flow through pipes 608. Drainage issues related to pitch may cause reduced flow, urine salts buildup and other issues. Certain types of replacement products that are ultra low-flow or water-free simply cannot be used in old buildings due to the age of the drain lines. Older piping and materials may flake creating particulates in the water which may cause clogs and failures in solenoids, filters, and other moving parts in the plumbing system 502. Plumbing code and location regulations also change over time. Building size and height 606 also has plumbing impacts as higher floors in a high-rise building will have common problems related to low pressure and pumps used to increase water pressure for higher floors in a building can cause particulates, cavitation, and other issues in the plumbing system.

Referring to the location in building 612 (e.g., restroom, kitchen, mechanical room, drinking fountain, and similar areas requiring water), additional plumbing impacts are considered. The usage rate/traffic 614 in a location is the primary factor underlying fail rates. Materials have predictable failure rates based on the number of times they have been operated. The restrooms in a location in building 612 may be affected by building traffic patterns, e.g., whether it is a public restroom or private (in room) restroom. Additionally, common traffic patterns in a restroom may cause higher or lower usage depending on the position of the toilet, urinal or sink. The valve type or unit 616 has an impact as electronic valves may be much more sensitive to water conditions and other environmental factors. Location environmental factors 618, e.g., an indoor location, outdoor location, air temperature, moisture, sunlight, and other factors, can affect equipment life. As with the work site 602, water conditions 620 will have plumbing impacts as chemicals, additives, mineral content and particulates in the water will vary within a building. Water temperature 622 also may have an impact as water at a higher temperature than the valve rating causes internal components to melt or fail faster. Frequently in a commercial kitchen, the water temperature will be kept higher for dishwashing and sanitation; if the temperature is too high, it may cause the valves to fail at a much faster rate. Safety issues such as scalding may also potentially occur in this situation. A water temperature held in a range of 20-50 degrees Celsius (68-122 Fahrenheit) may cause dangerous microbial over-growth or a biofilm to develop in the plumbing system. These conditions can be deadly in healthcare or other environments with people who have a suppressed immune response.

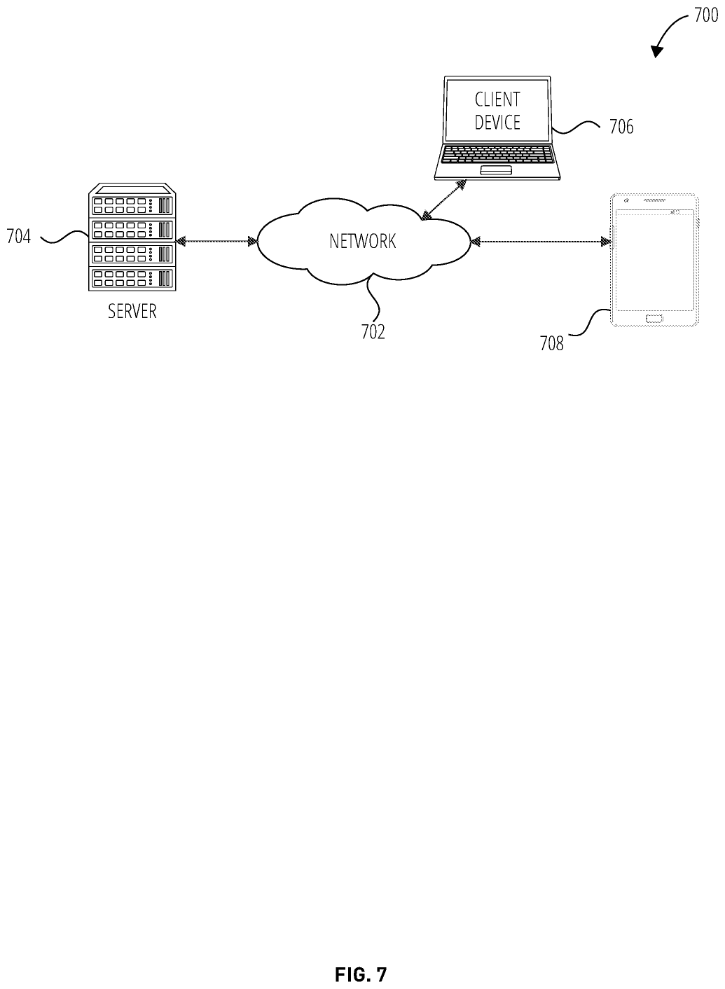

FIG. 7 illustrates a simplified system 700 in which a server 704, a client device 706 and/or a mobile device 708 are connected to a network 702.

In various embodiments, the network 702 may include the Internet, a local area network (“LAN”), a wide area network (“WAN”), and/or other data network. In addition to traditional data-networking protocols, in some embodiments, data may be communicated according to protocols and/or standards including near field communication (“NFC”), Bluetooth, power-line communication (“PLC”), and the like. In some embodiments, the network 702 may also include a voice network that conveys not only voice communications, but also non-voice data such as Short Message Service (“SMS”) messages, as well as data communicated via various cellular data communication protocols, and the like.

In various embodiments, the client device 706 may include desktop PCs, mobile phones, laptops, tablets, wearable computers, or other computing devices that are capable of connecting to the network 702 and communicating with the server 704, such as described herein.

In various embodiments, additional infrastructure (e.g., short message service centers, cell sites, routers, gateways, firewalls, and the like), as well as additional devices may be present. Further, in some embodiments, the functions described as being provided by some or all of the server 704 and the client device 706 may be implemented via various combinations of physical and/or logical devices. However, it is not necessary to show such infrastructure and implementation details in FIG. 7 in order to describe an illustrative embodiment.

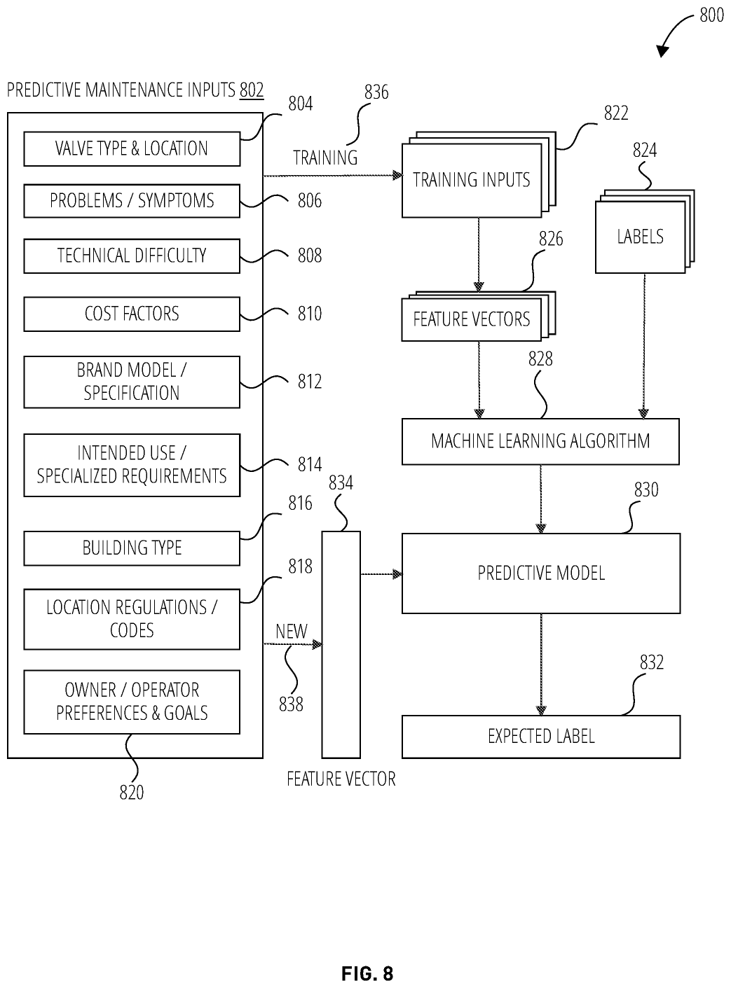

FIG. 8 illustrates a predictive maintenance diagram 800 showing how predictive maintenance inputs 802 may be used in a machine learning system. To achieve an expected label 832, that is, the final output of the predictive model 830, the predictive maintenance inputs 802 are either aggregated through a training path 836 as training inputs 822 or serve as new inputs to the predictive model 830 via the new input path 838. Once all predictive maintenance inputs 802 have followed a training path 836 and been aggregated as training inputs 822, their feature vectors 826 act as inputs to a machine learning algorithm 828. Additional labels 824 may also serve as inputs to the machine learning algorithm 828 apart from the feature vectors 826. Outputs from the machine learning algorithm 828 act as inputs to the predictive model 830, which thereby produced the expected label 832.

A new feature vector 834, that is an n-dimensional vector of numerical features, is created from predictive maintenance inputs 802 along the new input path 838. The feature vector 834 provides a direct input to the predictive model 830.

The predictive maintenance inputs 802 comprise a number of individual variables. Valve type & location 804 refers to the valve at a shower, faucet, toilet, kitchen, laboratory or similar water-using area. Problems/symptoms 806 refer to a number of situations a plumber may encounter, e.g., dripping water, lack of water, handle sticking, flushing problems (for toilets), incorrect water temperature, odors, etc. Technical difficulty 808 refers to requirements for advanced knowledge, specialized tools, tradesman in addition to plumbers (e.g., electrician, carpenter, HVAC tech), and/or a requirement for water shutoff to a room, floor, wing, or building. Cost factors 810 relate to the technical difficulty, the age of the original equipment, and/or the surrounding environment (e.g., in cement, through an exterior wall, in a vault under water, whether the building is on a historic registry). Consideration of the brand model/specification 812 concerns the availability of an exact replacement, obsolescence, and/or changes in the footprint of a replacement. The intended use/specialized requirements 814 input refers to whether the water in question is to be used for an ice machine, hospital, and/or public park, as drinking water, non-potable water, reclaimed water, and/or irrigation, is ADA-compliant and/or vandal-resistant. The building type 816 could refer to a hospital, school, park, office, hotel, multi-family dwelling, correctional facility, and so on. The local location regulations/codes 818 refers to government rules that change over time, e.g., recent examples include updated low lead requirements, lower flow requirements for fixtures including faucets, showers, toilets, urinals, etc. Finally, owner/operator preferences & goals 820 refers to variable of additional interest to the owner or operator of a location, e.g., sustainability, antimicrobial, vandal-resistant, LEED certified, and so on.

The machine learning system may include a basic deep neural network 900, based on a collection of connected units or nodes called artificial neurons which loosely model the neurons in a biological brain. Each connection, like the synapses in a biological brain, can transmit a signal from one artificial neuron to another. An artificial neuron that receives a signal can process it and then signal additional artificial neurons connected to it.

In common implementations, the signal at a connection between artificial neurons is a real number, and the output of each artificial neuron is computed by some non-linear function (the activation function) of the sum of its inputs. The connections between artificial neurons are called ‘edges’ or axons. Artificial neurons and edges typically have a weight that adjusts as learning proceeds. The weight increases or decreases the strength of the signal at a connection. Artificial neurons may have a threshold (trigger threshold) such that the signal is only sent if the aggregate signal crosses that threshold. Typically, artificial neurons are aggregated into layers. Different layers may perform different kinds of transformations on their inputs. Signals travel from the first layer (the input layer 902), to the last layer (the output layer 906), possibly after traversing one or more intermediate layers, called hidden layers 904.

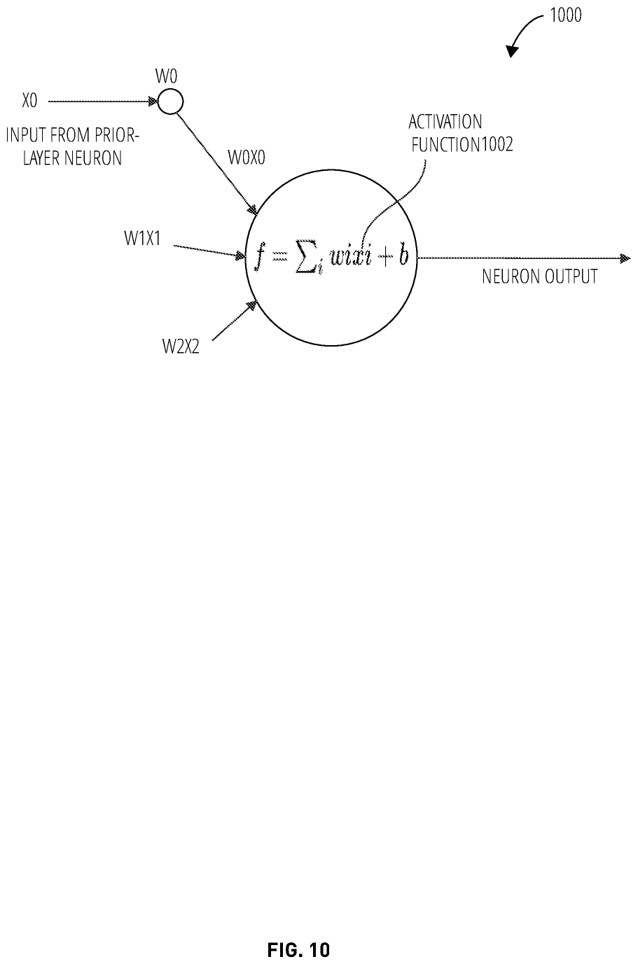

Referring to FIG. 10, an artificial neuron 1000 receiving inputs from predecessor neurons may include the following components:
inputs xᵢ;
weights wᵢ applied to the inputs;
an optional threshold (b), which stays fixed unless changed by a learning function; and
an activation function 1002 that computes the output from the previous neuron inputs and threshold, if any.

An input neuron has no predecessor but serves as input interface for the whole network. Similarly an output neuron has no successor and thus serves as output interface of the whole network.

The network includes connections, each connection transferring the output of a neuron in one layer to the input of a neuron in a next layer. Each connection carries an input x and is assigned a weight w.

The activation function 1002 often has the form of a sum of products of the weighted values of the inputs of the predecessor neurons.

The learning rule is a rule or an algorithm which modifies the parameters of the neural network, in order for a given input to the network to produce a favored output. This learning process typically involves modifying the weights and thresholds of the neurons and connections within the network.

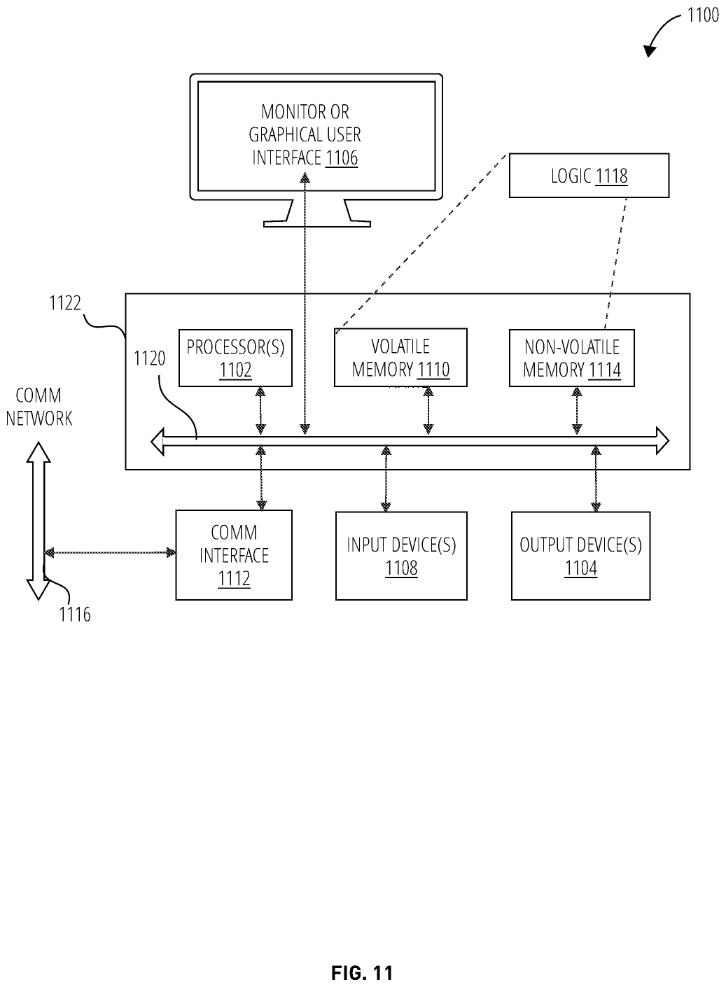

FIG. 11 is an example block diagram of a computing device 1100 that may incorporate embodiments of the present invention. FIG. 11 is merely illustrative of a machine system to carry out aspects of the technical processes described herein and does not limit the scope of the claims. One of ordinary skill in the art would recognize other variations, modifications, and alternatives. In one embodiment, the computing device 200 typically includes a monitor or graphical user interface 1106, a data processing system 1122, a communication network interface 1112, input device(s) 1108, output device(s) 1104, and the like.

As depicted in FIG. 11, the data processing system 1122 may include one or more processor(s) 1102 that communicate with a number of peripheral devices via a bus subsystem 1120. These peripheral devices may include input device(s) 1108, output device(s) 1104, communication network interface 1112, and a storage subsystem, such as volatile memory 1110 and nonvolatile non-volatile memory 1114.

The volatile memory 1110 and/or the non-volatile memory 1114 may store computer-executable instructions and thus forming logic 1118 that when applied to and executed by the processor(s) 1102 implement embodiments of the processes disclosed herein.

The input device(s) 1108 include devices and mechanisms for inputting information to the data processing system 1122. These may include a keyboard, a keypad, a touch screen incorporated into the user interface 1106, audio input devices such as voice recognition systems, microphones, and other types of input devices. In various embodiments, the input device(s) 1108 may be embodied as a computer mouse, a trackball, a track pad, a joystick, wireless remote, drawing tablet, voice command system, eye tracking system, and the like. The input device(s) 1108 typically allow a user to select objects, icons, control areas, text and the like that appear on the user interface 1106 via a command such as a click of a button or the like.

The output device(s) 1104 include devices and mechanisms for outputting information from the data processing system 1122. These may include the user interface 1106, speakers, printers, infrared LEDs, and so on as well understood in the art.

The communication network interface 1112 provides an interface to communication networks (e.g., communication network 1116) and devices external to the data processing system 1122. The communication network interface 1112 may serve as an interface for receiving data from and transmitting data to other systems. Embodiments of the communication network interface 1112 may include an Ethernet interface, a modem (telephone, satellite, cable, ISDN), (asynchronous) digital subscriber line (DSL), FireWire, USB, a wireless communication interface such as Bluetooth or Wi-Fi, a near field communication wireless interface, a cellular interface, and the like.

The communication network interface 1112 may be coupled to the communication network 1116 via an antenna, a cable, or the like. In some embodiments, the communication network interface 1112 may be physically integrated on a circuit board of the data processing system 1122, or in some cases may be implemented in software or firmware, such as “soft modems”, or the like.

The computing device 200 may include logic that enables communications over a network using protocols such as HTTP, TCP/IP, RTP/RTSP, IPX, UDP and the like.

The volatile memory 1110 and the non-volatile memory 1114 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1110 and the non-volatile memory 1114 may be configured to store the basic programming and data constructs that provide the functionality of the disclosed processes and other embodiments thereof that fall within the scope of the present invention.

Logic 1118 that implements embodiments of the present disclosure may be stored in the volatile memory 1110 and/or the non-volatile memory 1114. Said logic 1118 may be read from the volatile memory 1110 and/or non-volatile memory 1114 and executed by the processor(s) 1102. The volatile memory 1110 and the non-volatile memory 1114 may also provide a repository for storing data used by the logic 1118.

The volatile memory 1110 and the non-volatile memory 1114 may include a number of memories including a main random access memory (RAM) for storage of instructions and data during program execution and a read only memory (ROM) in which read-only non-transitory instructions are stored. The volatile memory 1110 and the non-volatile memory 1114 may include a file storage subsystem providing persistent (non-volatile) storage for program and data files. The volatile memory 1110 and the non-volatile memory 1114 may include removable storage systems, such as removable flash memory.

The bus subsystem 1120 provides a mechanism for enabling the various components and subsystems of data processing system 1122 communicate with each other as intended. Although the communication network interface 1112 is depicted schematically as a single bus, some embodiments of the bus subsystem 1120 may utilize multiple distinct busses.

It will be readily apparent to one of ordinary skill in the art that the computing device 200 may be a device such as a smartphone, a desktop computer, a laptop computer, a rack-mounted computer system, a computer server, or a tablet computer device. As commonly known in the art, the computing device 200 may be implemented as a collection of multiple networked computing devices. Further, the computing device 200 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

The methods and system in this disclosure are described in the preceding on the basis of several preferred embodiments. Different aspects of different variants are considered to be described in combination with each other such that all combinations, upon reading by a skilled person in the field on the basis of this document, may be regarded as being read within the concept of the disclosure. The preferred embodiments do not limit the extent of protection of this document.

Having thus described embodiments of the present disclosure of the present application in detail and by reference to illustrative embodiments thereof, it will be apparent that modifications and variations are possible without departing from the scope of the present disclosure.

What is claimed is:

1. A method for providing predictive maintenance and asset tracking in a plumbing system comprising:
operating a user interface on a mobile device to:
receive work site details comprising location information and a job description for a work site;
operate a wireless sensor to detect an asset tag and collect diagnostic information, from diagnostic sensors, from a plumbing part; and
operate an image sensor to capture imaging information from the plumbing part;
communicating the work site details, the asset tag, the diagnostic information, and the imaging information to a heuristics engine;
selecting a work site layout, a plumbing diagram, and location regulations from a worksite database through a selector configured by the work site details;
selecting a part description, a part history, tolerances, and servicing information from a parts database through at least one of the selector configured by the asset tag and the selector configured by the imaging information;
identifying a maintenance schedule and maintenance solutions for the plumbing part through comparison of the part history, the tolerances, the servicing information, and the plumbing diagram to the diagnostic information and the job description through operation of a comparator;
generating suggested maintenance for other related plumbing parts through operation of the heuristics engine; and
displaying maintenance information comprising the maintenance solutions and the maintenance schedule, the suggested maintenance, and the part description through the user interface.

2. The method of claim 1 further comprising:
communicating a replacement part order to an ordering service in response to identification of the maintenance solutions.

3. The method of claim 1, wherein the location information comprises at least one of:
usage rate;
foot traffic;
valve type;
location environmental factors;
water conditions, including water quality and chemicals and additives introduced by municipal water treatment; and
water temperature.

4. The method of claim 3, where the usage rate is determined by the location of a plumbing source within a building.

5. The method of claim 3, where the usage rate is determined by the specific valve location in an area within a building.

6. The method of claim 1, wherein the work site details include building-specific data dependent on the building geographical location.

7. The method of claim 6, wherein the building-specific data comprises at least one of:
water conditions, including water quality and chemicals and additives introduced by municipal water treatment;
building age, including drainage issues and particulates;
volume of pipe flow;
building size; and
building height.

8. The method of claim 1, further comprising operating a machine learning system to provide the suggested maintenance recommendations, wherein the machine learning system has been trained, using predictive maintenance inputs, to identify the suggested maintenance.

9. The method of claim 8, wherein the predictive maintenance inputs include at least one of the following inputs:
valve type and location;
diagnosed problems or symptoms;
technical difficulty of replacement or repair;
cost factors for replacement or repair;
current brand, current model or specification;
intended use and specialized requirements;
building type;
the location regulations or codes;
owner preferences or goals; and
operator preferences or goals.

10. The method of claim 1, wherein the location regulations comprise a version of the Uniform Plumbing Code.

11. A system comprising:
a wireless sensor;
an image sensor;
a mobile device with a user interface;
a processor; and
a memory storing instructions that, when executed by the processor, configure the system to:
operate the user interface on the mobile device to:
receive work site details comprising location information and a job description for a work site;
operate the wireless sensor to detect an asset tag and collect diagnostic information, from diagnostic sensors, from a plumbing part; and
operate the image sensor to capture imaging information from the plumbing part;
communicate the work site details, the asset tag, the diagnostic information, and the imaging information to a heuristics engine;
select a work site layout, a plumbing diagram, and location regulations from a worksite database through a selector configured by the work site details;
select a part description, a part history, tolerances, and servicing information from a parts database through at least one of the selector configured by the asset tag and the selector configured by the imaging information;
identify a maintenance schedule and maintenance solutions for the plumbing part through comparison of the part history, the tolerances, the servicing information, and the plumbing diagram to the diagnostic information and the job description through operation of a comparator;
generate suggested maintenance for other related plumbing parts through operation of the heuristics engine; and
display maintenance information comprising the maintenance solutions and the maintenance schedule, the suggested maintenance, and the part description through the user interface.

12. The system of claim 11, wherein the instructions further configure the system to communicate a replacement part order to an ordering service in response to identification of the maintenance solutions.

13. The system of claim 11, wherein the selector within the heuristics engine configured by the work site details is used to select the work site layout, the plumbing diagram, and the location regulations from the worksite database.

14. The system of claim 11, wherein the selector within the heuristics engine configured by the asset tag is used to select the part description, the part history, the tolerances, and the servicing information from the parts database.

15. The system of claim 11, wherein the selector within the heuristics engine configured by the imaging information is used to select the part description, the part history, the tolerances, and the servicing information from the parts database.

16. The system of claim 11, further comprising:
a machine learning system configured to:
provide the suggested maintenance recommendations, wherein the machine learning system has been trained, using predictive maintenance inputs, to identify the suggested maintenance.

17. The system of claim 16, wherein the predictive maintenance inputs include at least one of:
valve type and location;
diagnosed problems or symptoms;
technical difficulty of replacement or repair;
cost factors for replacement or repair;
current brand, current model or specification;
intended use and specialized requirements;
building type;
the location regulations or codes;
owner preferences or goals; and
operator preferences or goals.

18. The system of claim 11, wherein the location information comprises at least one of:
usage rate;
foot traffic;
valve type;
location environmental factors;
water conditions, including water quality and chemicals and additives introduced by municipal water treatment; and
water temperature.

19. The system of claim 11, wherein the work site details include building-specific data dependent on the building geographical location.

20. The system of claim 19, wherein the building-specific data comprises at least one of:
water conditions, including water quality and chemicals and additives introduced by municipal water treatment;
building age, including drainage issues and particulates;
volume of pipe flow;
building size; and
building height.
